(19) United States
(12) Patent Application Publication
(10) Pub. No.: US 2003/0114150 A1
(43) Pub. Date: Jun. 19, 2003

(54) Mobile telephone and its control method

(75) Inventor: Keiichi Hayashi, Kanagawa (JP)

Correspondence Address: SCULLY SCOTT MURPHY & PRESSER, PC, 400 GARDEN CITY PLAZA, GARDEN CITY, NY, 11530

(73) Assignee: NEC Corporation, Tokyo (JP)

(21) Appl. No.: 10/314,934

(22) Filed: Dec. 9, 2002

(30) Foreign Application Priority Data
Dec. 13, 2001 (JP) 379521/2001

(51) Int. Cl. H04M 3/00

(52) U.S. Cl. 455/418; 455/419

(57) ABSTRACT

A mobile telephone according to the invention is provided with a controller for executing an application program, a speaker operated according to an instruction of the controller, a light emitting element and a vibrator, the controller notifies the application program of information for controlling either or both of the lighting of the light emitting element or/and the vibration of the vibrator in synchronization with the performance of melody data when the melody data is performed via the speaker while the application program including the performance of the melody data is executed, either or both a pattern of the lighting of the light emitting element or/and a pattern of the vibration of the vibrator is/are controlled in synchronization with the performance of the melody data and the application program is executed.

### BACKGROUND OF THE INVENTION

1. Field of the Invention

The present invention relates to a mobile telephone and a method of controlling the mobile telephone.

2. Description of the Related Art

Some conventional type mobile telephones activate an operational pattern such as the lighting of LED and the vibration of a vibrator in time with a tune of the downloaded melody when they reproduce a melody downloaded via a network beforehand. However, a signal (called an event in this specification) for synchronizing the operational pattern such as the lighting of LED and the vibration of the vibrator with the operation of the following application program cannot be sent to LED or the vibrator when the conventional type mobile telephone executes an application program written in Java (trademark) and an application program stored in the mobile telephone. Therefore, heretofore, when the mobile telephone executes the Java application program or the application program stored in the mobile telephone, an instruction to operate such as light LED and vibrate the vibrator depends upon the tempo of a reproduced melody and elapsed time since the start of performance. Therefore, in an application such as “karaoke” (singing in time with an instrumental accompaniment, seeing lyrics), there is a problem that the display of lyrics is delayed, compared with the proceedings of a melody.

In the meantime, some mobile telephones can notify a Java application program of an event in synchronization with a melody, however, as there is constraint in throughput between CPU and a memory with which such a mobile telephone is respectively provided, the performance of a melody while a Java application program is executed and the use of the vibrator or LED cannot be simultaneously made. In other words, in case a melody is performed in a Java application, there is constraint that the performance of the melody and the vibration of the vibrator or the performance of the melody and the lighting of LED cannot be simultaneously processed.

### SUMMARY OF THE INVENTION

The invention is made in view of the problems and the object is to provide a mobile telephone in which the problem described above that display on a screen delays for the performance of a melody, the problem described above that when a melody is reproduced in a Java application or an application stored in the mobile telephone, an event from melody data cannot be acquired and the problem that the vibration of the vibrator and the lighting of LED cannot be executed together are solved and its control method.

The mobile telephone according to the invention is provided with a controller for executing an application program, a speaker operated according to the instruction of the controller, a light emitting element and a vibrator, the controller notifies the application program of information for controlling either or both of the lighting of the light emitting element or/and the vibration of the vibrator in synchronization with the performance of melody data when the melody data is performed via the speaker while the application program including the performance of the melody data is executed, either or both of a pattern of the lighting of the light emitting element or/and a pattern of the vibration of the vibrator is/are controlled in synchronization with the performance of the melody data and the application program is executed.

The information for controlling either or both of the lighting of the light emitting element or/and the vibration of the vibrator in synchronization with the performance of the melody data is written in the melody data.

The melody data is acquired from a server connected to a telecommunication network for distributing melody data via the telecommunication network.

The application program is an application program written in Java (trademark).

The application program is an application program stored in the mobile telephone.

Also, a method of controlling the mobile telephone according to the invention is characterized in that in the mobile telephone provided with the controller for executing an application program, the speaker operated according to an instruction of the controller, the light emitting element and the vibrator, the controller notifies the application program of information for controlling either or both of the lighting of the light emitting element or/and the vibration of the vibrator in synchronization with the performance of melody data when the melody data is performed via the speaker while the application program including the performance of the melody data is executed, either or both of a pattern of the lighting of the light emitting element or/and a pattern of the vibration of the vibrator is/are controlled in synchronization with the performance of the melody data when the melody data is performed via the speaker and the application program is executed.

The information for controlling either or both of the lighting of the light emitting element or/and the vibration of the vibrator in synchronization with the performance of the melody data is written in the melody data. The melody data is acquired from a server connected to a telecommunication network for distributing a melody via the telecommunication network.

The application program is a Java application program.

The application program is an application program stored in the mobile telephone.

According to the invention, the problem of delay caused due to vibration in the display on a screen of melody data and the problem that the ring of melody data, the vibration of the vibrator and the lighting of LED cannot be realized together in a Java application or an application stored in the mobile telephone are solved.

According to the invention, in call incoming and others, an event of the vibration of the vibrator or the lighting of LED can be notified a Java application or an application stored in the mobile telephone in synchronization with an arbitrary melody part when a melody is performed.

According to the invention, pattern information and timing information required for the event notified a Java application and an application stored in the mobile telephone can be reduced.

According to the invention, a ring in an application such as that written in Java, the vibrator and LED can be simultaneously used or the combination of a Java application and the vibrator and the combination of a Java application and LED are enabled.

### BRIEF DESCRIPTION OF THE DRAWINGS

The above and other objects, features and advantages of the present invention will become apparent from the following detailed description when taken with the accompanying drawings in which:

FIG. 1 shows the configuration of a network to which one embodiment of a mobile telephone according to the invention is applied;

FIG. 2 is a block diagram showing the configuration of the mobile telephone according to the invention;

FIG. 3 shows interrelation among CPU, atone generator, a vibrator and LED with which the mobile telephone according to the invention is provided;

FIG. 4 is a flowchart for CPU to set synchronization with the vibrator and LED in the mobile telephone according to the invention;

FIG. 5 is the flowchart following FIG. 4 from the setting of synchronization by CPU to the performance of a melody in the mobile telephone according to the invention;

FIG. 6 shows relation among a state of each port of CPU, event notice and synchronization with LED and the vibrator in the mobile telephone according to the invention;

FIG. 7 shows a format of synchronization information;

FIG. 8 shows a data format in case one sound is output per one tone; and

FIG. 9 shows a data format in case plural sounds are output per one tone.

### DETAILED DESCRIPTION OF THE PREFERRED EMBODIMENTS

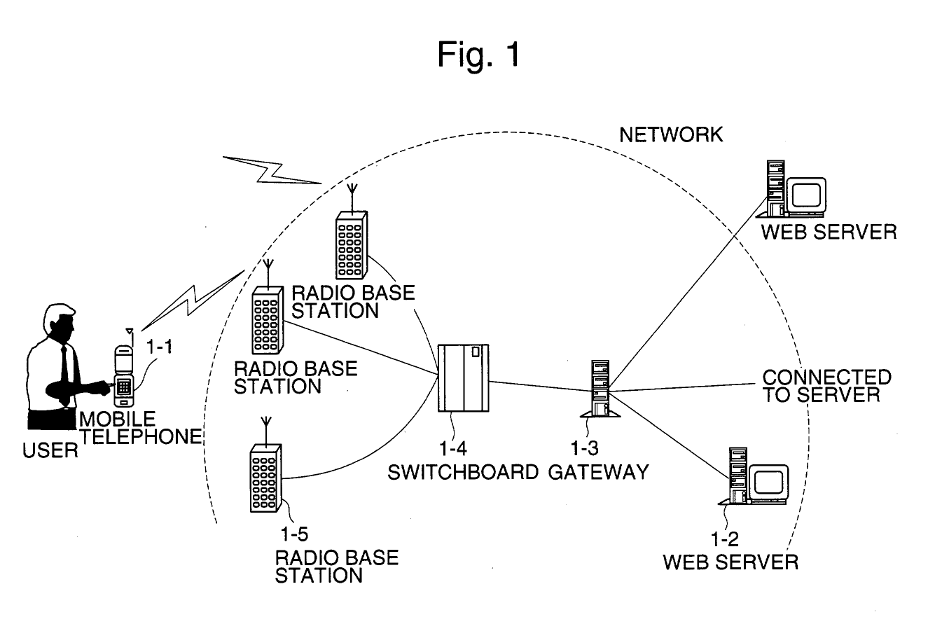

As shown in FIG. 1, a network is composed of a mobile telephone 1-1, a web server 1-2, a gate way 1-3, a switchboard 1-4 and a radio base station 1-5. The mobile telephone 1-1 acquires melody data from the web server 1-2 via the network.

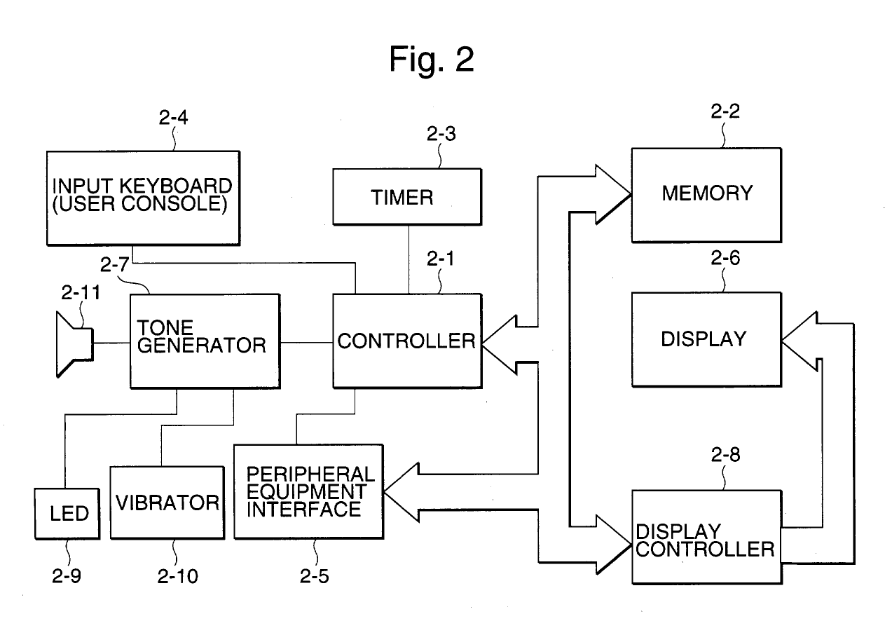

As shown in FIG. 2, the mobile telephone 1-1 is composed of a controller 2-1, a memory 2-2, a timer 2-3, an input keyboard 2-4, a peripheral equipment interface 2-5, a display 2-6, a tone generator 2-7, a display controller 2-8, LED 2-9, a vibrator 2-10 and a speaker 2-11. The tone generator controls LED 2-9, the vibrator 2-10 and the speaker 2-11 according to the instruction of the controller 2-1. Melody data acquired via the network by the mobile telephone 1-1 in advance is stored in the memory 2-2 in the mobile telephone and is reproduced when a call is made or when data is received according to a condition set in the mobile telephone 1-1.

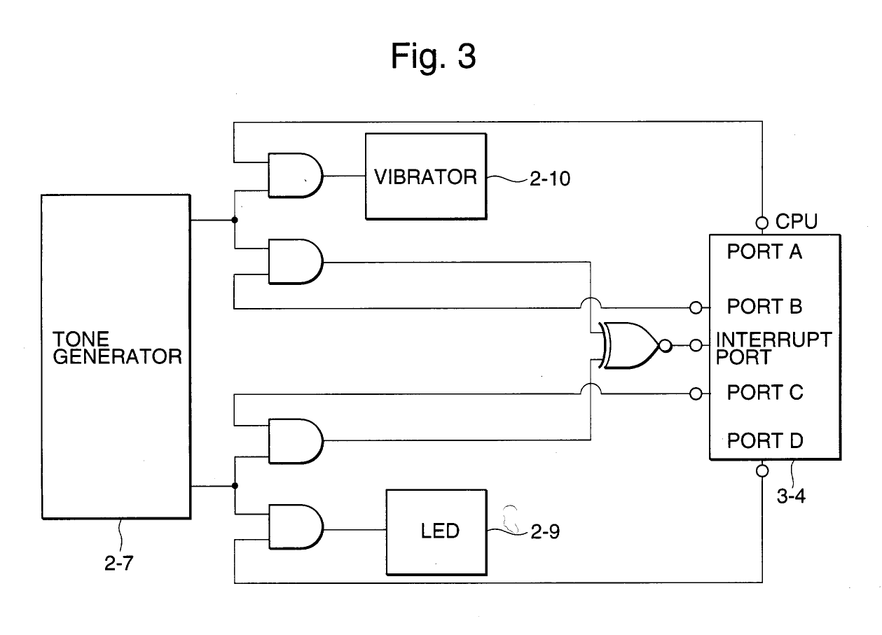

The controller 2-1 is provided with CPU 3-4. CPU 3-4 is connected to the tone generator 2-7, LED 2-9 and the vibrator 2-10 as shown in FIG. 3.

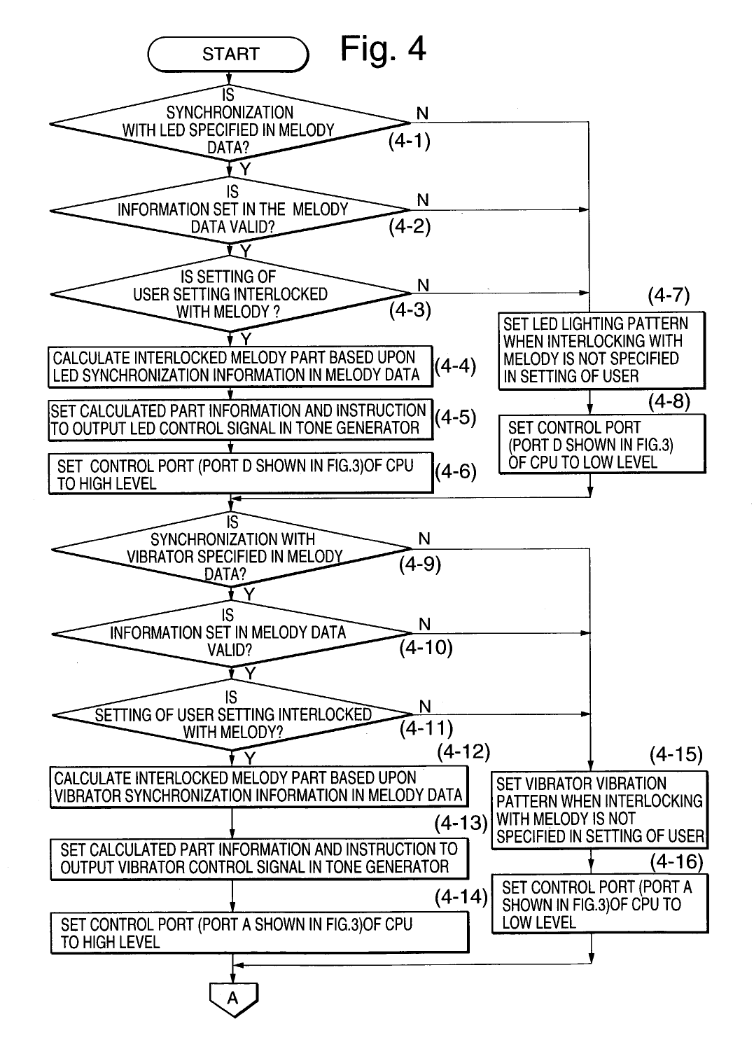

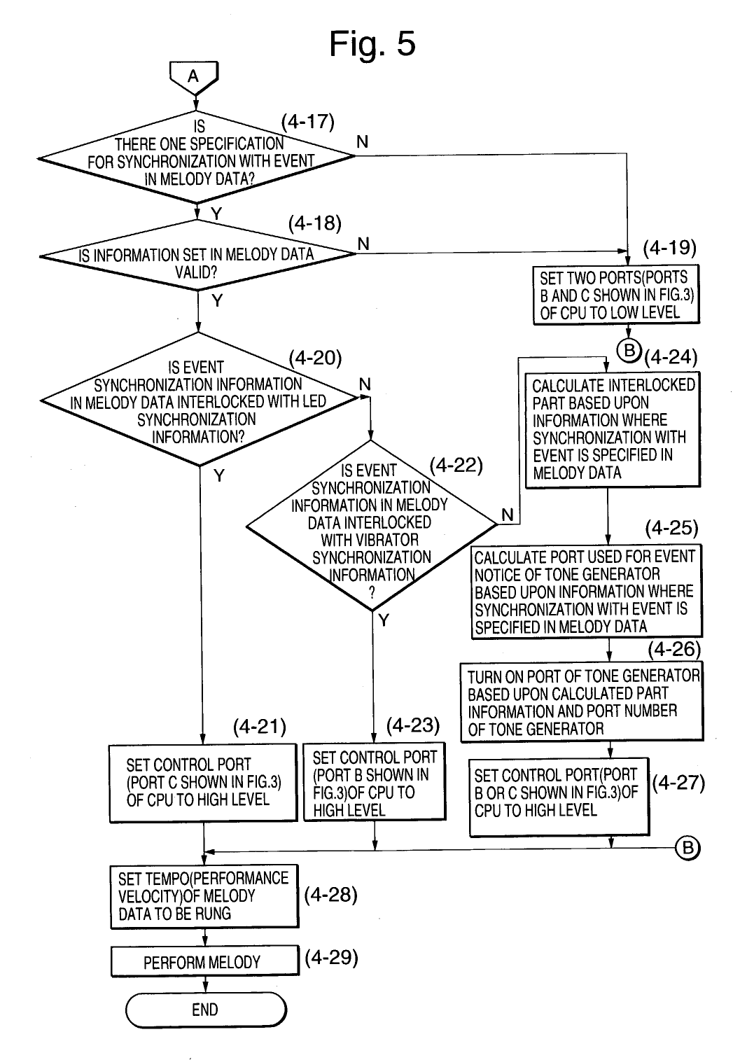

Next, according to a flowchart in FIGS. 4 and 5, data analysis when a melody is performed, event notice setting and performance will be clarified.

In the mobile telephone 1-1, the controller 2-1 activates a Java (trademark) application program or an application program built in the mobile telephone on CPU 3-4. In case the melody data acquired from the web server beforehand is played while CPU 3-4 executes the application program, it is checked whether LED synchronization information is specified in the melody data or not (a step (4-1)).

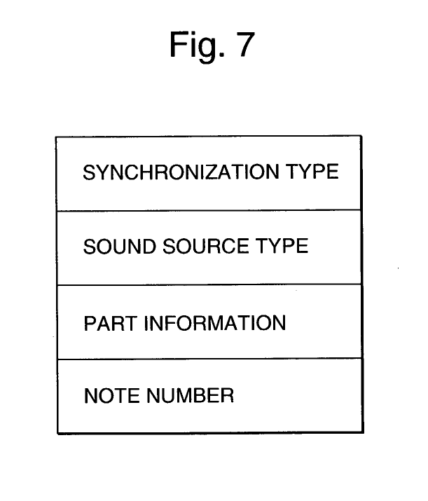

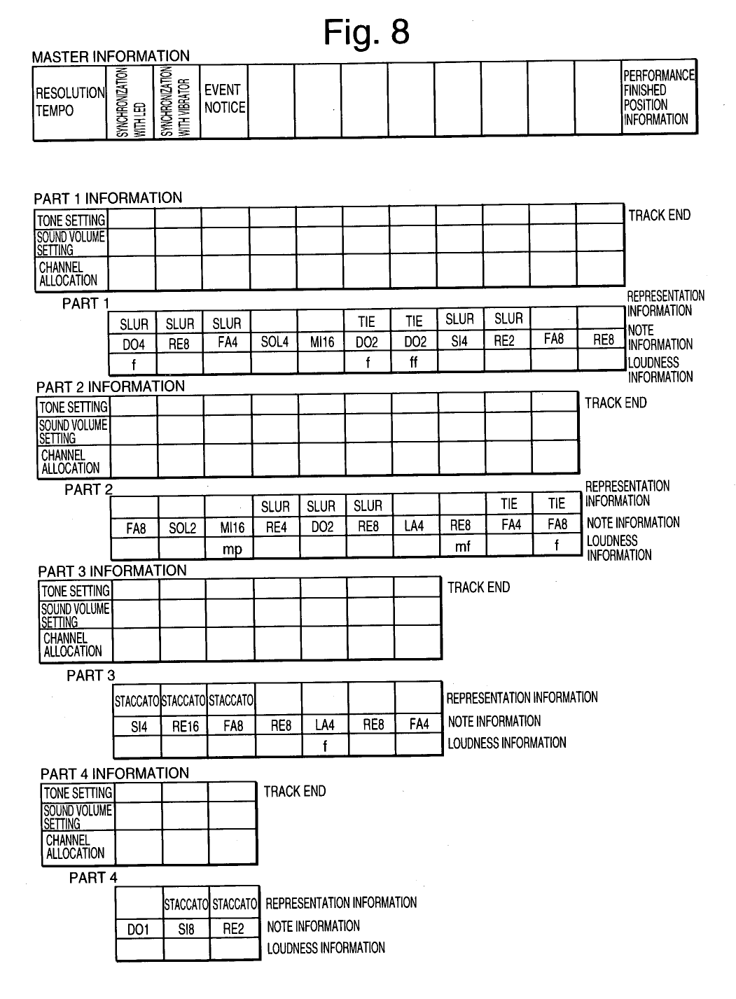

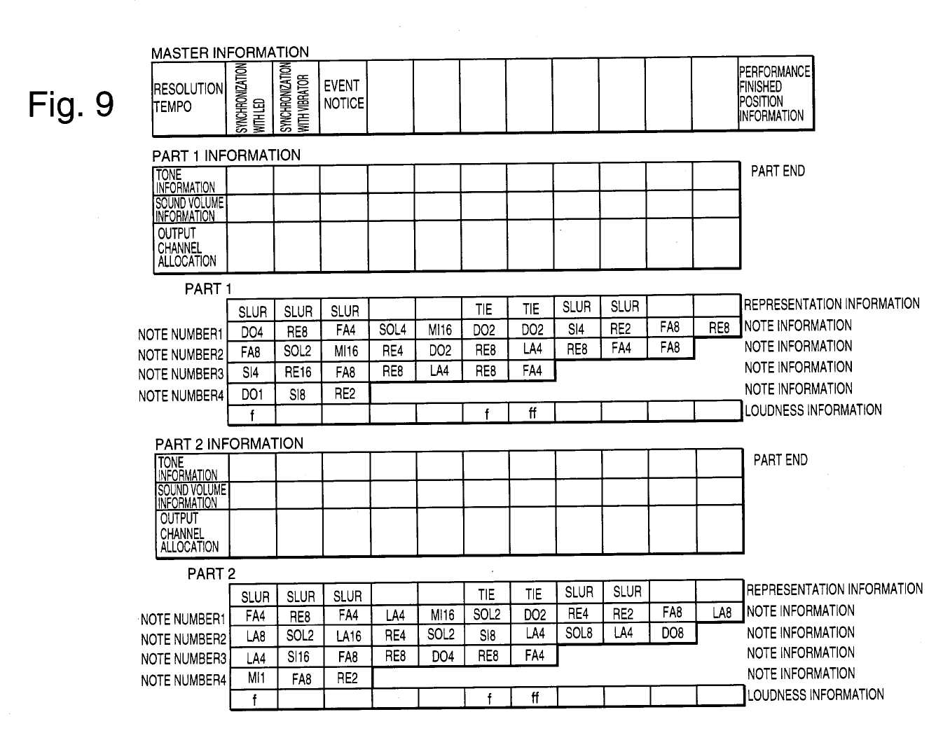

The synchronization information is written in master information for managing the whole melody data as shown in FIGS. 8 and 9 and the synchronization information includes a synchronization type, a sound source type, part information and a note number as shown in FIG. 7.

In a field of the synchronization type, information for checking which of LED, the vibrator and event notice is synchronized and information for checking whether LED, the vibrator and event notice are interlocked or not are set. In case both LED and the vibrator are to be synchronized, synchronization information with LED and the vibrator is set and in case LED, the vibrator and event notice are all synchronized, synchronization information with three all is set.

In a field of the sound source type, information for distinguishing a sound source for outputting one sound per one tone and a sound source for outputting plural sounds is set.

In a field of the part information, a part number of a part to be synchronized is set.

In a field of the note number, information for checking which note is synchronized in case the sound source that can output plural sounds simultaneously per one tone is specified in the field of the sound source type is set.

In FIG. 8, the data format of the melody data in the case of the output of one sound per one tone is shown. In FIG. 9, the data format of the melody data in the case of the output of plural sounds per one tone is shown.

The flowchart shown in FIGS. 4 and 5 will be described again.

In case synchronization with LED is not specified, a pattern of the lighting of LED in that case is set (the step (4-7)) and a control port (a port D shown in FIG. 3) of CPU 3-4 is set to a low level (the step (4-8)).

In case synchronization with LED is specified in the melody data, it is checked whether setting in the data is valid or not (a step (4-2)).

In case the setting in the data is invalid and in case synchronization with LED is not specified, the pattern of the lighting of LED is set (the step (4-7)) and the control port (the port D shown in FIG. 3) of CPU 3-4 is set to a low level (the step (4-8)).

In case the setting in the data is valid, it is checked whether setting input by a user of the mobile telephone via the input keyboard 2-4 is setting for interlocking the melody and the operation of LED or setting for not interlocking them (a step (4-3)).

In case the setting for interlocking the melody and the operation of LED is made, the part to be synchronized of the melody is calculated based upon LED synchronization information (a step (4-4)), and the calculated information and setting for turning on the output of an LED control signal are set in the tone generator 2-7 (a step (4-5)).

After the setting in the tone generator 2-7 is completed, the control port (the port D shown in FIG. 3) of CPU 3-4 is set to a high level (a step (4-6)) and the setting for interlocking with LED 2-9 is completed.

In case the user specifies that the operation of LED and the melody are not interlocked (the step (4-3), the pattern of the lighting of LED in that case is set (the step (4-7)) and the control port (the port D shown in FIG. 3) of CPU 3-4 is set to a low level (the step (4-8)).

Next, the setting of the vibrator 2-10 is checked according to the similar procedure to LED 2-9.

First, it is checked whether vibrator synchronization information is specified in the melody data for ringing or not (a step (4-9)).

In case synchronization with the vibrator is not specified, a vibrational pattern of the vibrator 2-10 in that case is set (a step (4-15)) and a control port (a port A shown in FIG. 3) of CPU 3-4 is set to a low level (a step (4-16)).

In case synchronization with the vibrator is specified, it is checked whether setting in the data is valid or not (a step (4-10)).

In case the setting in the data is invalid, the vibrational pattern of the vibrator 2-10 in that case is set (the step (4-15)) and the control port (the port A shown in FIG. 3) of CPU 3-4 is set to a low level (the step (4-16)).

In case the setting in the data in which synchronization with the vibrator is specified is valid, it is checked whether the user specifies interlocking with the melody or not (a step (4-11)), in case the interlocking is set, a part to be synchronized of the melody is calculated based upon vibrator synchronization information (a step (4-12)) and setting for turning on the output of the calculated information and a vibration control signal is made in the tone generator 2-7 (a step (4-13)).

After the setting in the tone generator 2-7 is completed, the control port (the port A shown in FIG. 3) of CPU 3-4 is set to a high level (a step (4-14)) and setting for interlocking the vibrator 2-10 is completed.

In case the user specifies that the vibrator is not interlocked with the melody, a vibrational pattern of the vibrator in that case is set (the step (4-15)) and the control port (the port A shown in FIG. 3) of CPU is set to a low level (the step (4-16)).

Next, as shown in FIG. 5, when setting for synchronizing with LED 2-9 and the vibrator 2-10 is completed, it is checked whether synchronization with event notice is specified or not.

It is checked whether plural event notice synchronization informations are specified in the melody data for ringing or not (a step (4-17)).

In case plural event notice synchronization informations are specified, two ports (ports B and C shown in FIG. 3) of CPU are set to a low level to invalidate an event notice function (a step (4-19)).

In case one event notice synchronization information is specified in the melody data, it is checked whether the setting of the event notice synchronization information is valid or not (a step (4-18)).

In case the setting of the event notice synchronization information in the data is invalid, the two ports (the ports B and C shown in FIG. 3) of CPU are set to a low level to invalidate the event notice function (the step (4-19)).

In case the setting of the event notice synchronization information is valid, it is checked based upon the synchronization information whether the event notice is interlocked with LED 2-9 or the vibrator 2-10 or not (a step (4-20)) or (a step (4-22)) and in case setting for interlocking is made, the control port (the port C or the port B shown in FIG. 3) of CPU is set to a high level according to interlocking information (a step (4-21)) or (a step (4-23)).

In case the event notice is not interlocked with LED 2-9 or the vibrator 2-10, a part to be synchronized of the melody is calculated based upon the synchronization information (a step (4-24)) and a port of the tone generator 2-7 for outputting a synchronizing signal is calculated (a step (4-25)). Next, the port used for event notice is set in the tone generator 2-7 based upon the calculated information (a step (4-26)).

After the setting is completed, the control port (the port B or the port C shown in FIG. 3) of CPU 3-4 is set to a high level based upon a result calculated based upon the synchronization information (a step (4-27)).

When all setting related to synchronization and even notice is completed, the tempo (the performance velocity) of the melody to be rung is set in the tone generator 2-7 (a step (4-28)). The melody is rung according to the two setting (a step (4-29)).

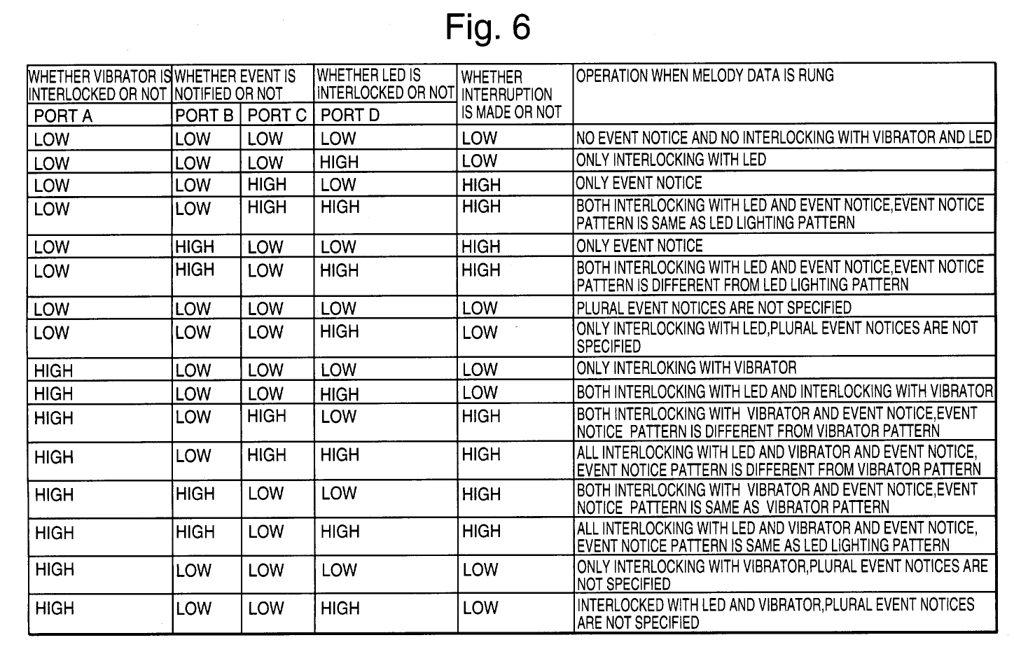

As a result of investigating synchronization information existing in the melody data in the flowchart shown in FIGS. 4 and 5, a state of each of the ports A to D of CPU 3-4 and a state of an input terminal of an interrupt port are as shown in FIG. 6.

As described above, the synchronization information written in the melody data is configured by the synchronization type, the sound source type, the part information and the note number as shown in FIG. 7.

In the field of the synchronization type, information for checking which of LED, the vibrator and event notice is synchronized and information for checking whether LED, the vibrator and event notice are interlocked or not are set.

In the field of the sound source type, information for distinguishing a sound source for outputting one sound per one tone and a sound source for outputting plural sounds is set.

In the field of the part information, a part number of a part to be synchronized is set.

In the field of the note number, information for checking which note is synchronized in case the sound source that can output plural sounds simultaneously per one tone is specified in the field of the sound source type is set.

These synchronization information is written in the master information for managing the whole melody data as shown in FIGS. 8 and 9. In FIGS. 8 and 9, the data format of the melody data is also shown.

Next, the application of the invention will be described.

A user of the following terminals can enjoy the operation of a character in a game and the display of a character string together with a melody in time with the performance of melody data by applying the invention to a mail terminal and a game terminal of the mobile telephone onto which the melody data can be downloaded from the web server and in a Java application and a game application run on which the downloaded melody data can be used.

Also, a user of game equipment can play a game in a link with the display of the game, a piece of music, either or both of LED or/and the vibrator by writing each information of the lighting of LED or the vibration of the vibrator and event notice in a part of melody data, the melody data, downloading the melody data onto the mobile game equipment and performing acquired musical data when the game is executed.

While the present invention has been described in connection with certain preferred embodiments, it is to be understood that the subject matter encompassed by the present invention is not limited to those specific embodiments. On the contrary, it is intended to include all alternatives, modifications, and equivalents as can be included within the spirit and scope of the following claims.

What is claimed is:

1. A mobile telephone, comprising:
a controller for executing an application program;
a speaker operated according to an instruction of the controller;
a light emitting element; and
a vibrator, wherein:
the controller notifies the application program of information for synchronizing either or both of the lighting of the light emitting element or/and the vibration of the vibrator with the performance of melody data when the melody data is performed via the speaker while the application program including the performance of the melody data is executed; and
either or both of a pattern of the lighting of the light emitting element or/and a pattern of the vibration of the vibrator is/are controlled in synchronization with the performance of the melody data and the application program is executed.

2. A mobile telephone according to claim 1, wherein:
information for controlling either or both of the lighting of the light emitting element or/and the vibration of the vibrator in synchronization with the performance of the melody data is written in the melody data.

3. A mobile telephone according to claim 1, wherein:
the melody data is acquired from a server connected to a telecommunication network for distributing the melody data via the telecommunication network.

4. A mobile telephone according to claim 1, wherein:
the application program is an application program written in Java (trademark).

5. A mobile telephone according to claim 1, wherein:
the application program is an application program stored in the mobile telephone.

6. A method of controlling a mobile telephone, wherein:
a controller notifies an application program of information for controlling either or both of the lighting of a light emitting element or/and the vibration of the vibrator in synchronization with the performance of melody data while the controller executes the application program including the performance of the melody data in the mobile telephone provided with the controller for executing the application program, a speaker operated according to an instruction of the controller, the light emitting element and the vibrator; and
either or both of a pattern of the lighting of the light emitting element or/and a pattern of the vibration of the vibrator is/are controlled in synchronization with the performance of the melody data when the melody data is performed via the speaker and the application program is executed.

7. A method of controlling a mobile telephone according to claim 6, wherein:
information for controlling either or both of the lighting of the light emitting element or/and the vibration of the vibrator in synchronization with the performance of the melody data is written in the melody data.

8. A method of controlling a mobile telephone according to claim 6, wherein:
the melody data is acquired from a server connected to a telecommunication network for distributing the melody data via the telecommunication network.

9. A method of controlling a mobile telephone according to claim 6, wherein:
the application program is a Java application program.

10. A method of controlling a mobile telephone according to claim 6, wherein:
the application program is an application program stored in the mobile telephone.
